(19) United States
(12) Patent Application Publication
(10) Pub. No.: US 2014/0055979 A1
(43) Pub. Date: Feb. 27, 2014

(54) ELECTRONIC DEVICE, ILLUMINATING DEVICE, ILLUMINATING METHOD, AND METHOD OF MANUFACTURING ILLUMINATING DEVICE

(71) Applicant: SONY CORPORATION, Tokyo (JP)

(72) Inventors: Hiroyuki Suzuki, Nagano (JP); Kiyoto Kusama, Nagano (JP)

(73) Assignee: SONY CORPORATION, Tokyo (JP)

(21) Appl. No.: 13/952,934

(22) Filed: Jul. 29, 2013

(30) Foreign Application Priority Data
Aug. 21, 2012 (JP) 2012-182797

(51) Int. Cl. F21V 9/08

(52) U.S. Cl. CPC F21V 9/08
USPC 362/84; 427/162

(57) ABSTRACT

Provided is an electronic device, including: a light source configured to emit light having a first wavelength; a first light reactive portion configured to emit visible light having a second wavelength when the first light reactive portion is excited by the light from the light source; a filter portion arranged between the light source and the first light reactive portion, the filter portion being configured to allow the light having the first wavelength to pass through, and to shield the visible light having the second wavelength emitted from the first light reactive portion; and a cover unit including a light transmissive portion, the light transmissive portion allowing a part of the visible light having the second wavelength emitted from the first light reactive portion to pass through.

### BACKGROUND

The present disclosure relates to an electronic device including a keyboard, an illuminating device applicable to the keyboard of the electronic device, an illuminating method performed by the illuminating device, and a method of manufacturing the illuminating device.

There is known an electronic device including the following keyboard (backlight keyboard). That is, a keycap main body of a keyboard is opaque. An alphabet or a symbol on the keycap is transparent. Backlight emits light to the keyboard, to thereby illuminate the alphabet or the symbol (for example, see Japanese Patent Application Laid-open No. 2008-71735 and Japanese Patent Application Laid-open No. 2010-170825.).

### SUMMARY

It is desirable to further increase optical decoration property of an electronic device such as a keyboard in order to increase expensive-looking and aesthetic impression.

In view of the above-mentioned circumstances, it is desirable to provide an electronic device capable of further increasing optical decoration property of a keyboard, an illuminating device applicable to the keyboard of the electronic device, an illuminating method performed by the illuminating device, and a method of manufacturing the illuminating device.

According to an embodiment of the present technology, there is provided an electronic device, including: a light source configured to emit light having a first wavelength; a first light reactive portion configured to emit visible light having a second wavelength when the first light reactive portion is excited by the light from the light source; a filter portion arranged between the light source and the first light reactive portion, the filter portion being configured to allow the light having the first wavelength to pass through, and to shield the visible light having the second wavelength emitted from the first light reactive portion; and a cover unit including a light transmissive portion, the light transmissive portion allowing a part of the visible light having the second wavelength emitted from the first light reactive portion to pass through.

The first light reactive portion may be between the light transmissive portion and the filter portion.

The cover unit may include an operation surface operated by a user, and the operation surface may include the light transmissive portion.

The light source may be configured to emit invisible light as the light having the first wavelength.

The electronic device may further include a second light reactive portion arranged between the light source and the filter portion, the second light reactive portion being configured to emit visible light having a third wavelength when the second light reactive portion is excited by the light having the first wavelength from the light source, the visible light having the third wavelength being different from the visible light having the second wavelength. The filter portion may be configured to further shield the visible light having the third wavelength emitted from the second light reactive portion.

The filter portion may be configured to allow a part of the visible light having the second wavelength emitted from the first light reactive portion to pass through.

According to an embodiment of the present technology, there is provided an illuminating device, including: a light source configured to emit light having a first wavelength; a first light reactive portion configured to emit visible light having a second wavelength when the first light reactive portion is excited by the light from the light source; a filter portion arranged between the light source and the first light reactive portion, the filter portion being configured to allow the light having the first wavelength to pass through, and to shield the visible light having the second wavelength emitted from the first light reactive portion; and a cover unit including a light transmissive portion, the light transmissive portion allowing a part of the visible light having the second wavelength emitted from the first light reactive portion to pass through.

According to an embodiment of the present technology, there is provided an illuminating method, including: emitting, from a light source, light having a first wavelength; emitting, from a first light reactive portion, visible light having a second wavelength when the first light reactive portion is excited by the light from the light source; allowing, by a filter portion arranged between the light source and the first light reactive portion, the light having the first wavelength to pass through, and shielding the visible light having the second wavelength emitted from the first light reactive portion; and allowing, by a light transmissive portion of a cover unit, a part of the visible light having the second wavelength emitted from the first light reactive portion to pass through.

According to an embodiment of the present technology, there is provided a method of manufacturing an illuminating device, including: layering a first light reactive portion on a surface of a cover unit, the first light reactive portion being configured to emit visible light having a second wavelength when the first light reactive portion is excited by light having a first wavelength; layering a filter portion on the first light reactive portion, the filter portion being configured to allow the light having the first wavelength to pass through, and to shield the visible light having the second wavelength emitted from the first light reactive portion; and forming a light transmissive portion on the cover unit, the light transmissive portion allowing a part of the visible light having the second wavelength emitted from the first light reactive portion to pass through.

As described above, according to the present technology, an electronic device and an illuminating device having higher optical decoration property may be provided.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a typical backlight keyboard of a related technology;

FIG. 2 is a perspective view showing an example of an electronic device of a first embodiment;

FIG. 3 is a schematic diagram showing the structure of a backlight keyboard;

FIG. 4 is a sectional view showing the structure of a keycap;

FIG. 5 is a schematic diagram showing a method of manufacturing the keycap;

FIG. 6 is a schematic diagram showing another backlight keyboard of a related technology;

FIG. 7 is a schematic diagram showing the structure of a backlight keyboard of a second embodiment;

FIG. 8 is a diagram showing the transparent wavelength of a bandpass filter;

FIG. 9 is a schematic diagram showing the structure of a keycap of a third embodiment;

FIG. 10 is a schematic diagram showing the structure of a keycap of a fourth embodiment;

FIG. 11 is a diagram showing the transparent wavelength of a bandpass filter;

FIG. 12 is a schematic diagram showing a keycap of a modification 4;

FIG. 13 is a schematic diagram showing a keycap of a modification 5;

FIG. 14 is a schematic diagram showing a keycap of a modification 6;

FIG. 15 is a schematic diagram showing a keycap of a modification 7;

FIG. 16 is a schematic diagram showing a keycap of a modification 8;

FIG. 17 is a schematic diagram showing a keycap of a modification 9; and

FIG. 18 is a schematic diagram showing a keycap of a modification 10.

### DETAILED DESCRIPTION OF EMBODIMENTS

Hereinafter, embodiments of the present disclosure will be described with reference to the drawings.

### First Embodiment

### [Structure of Electronic Device]

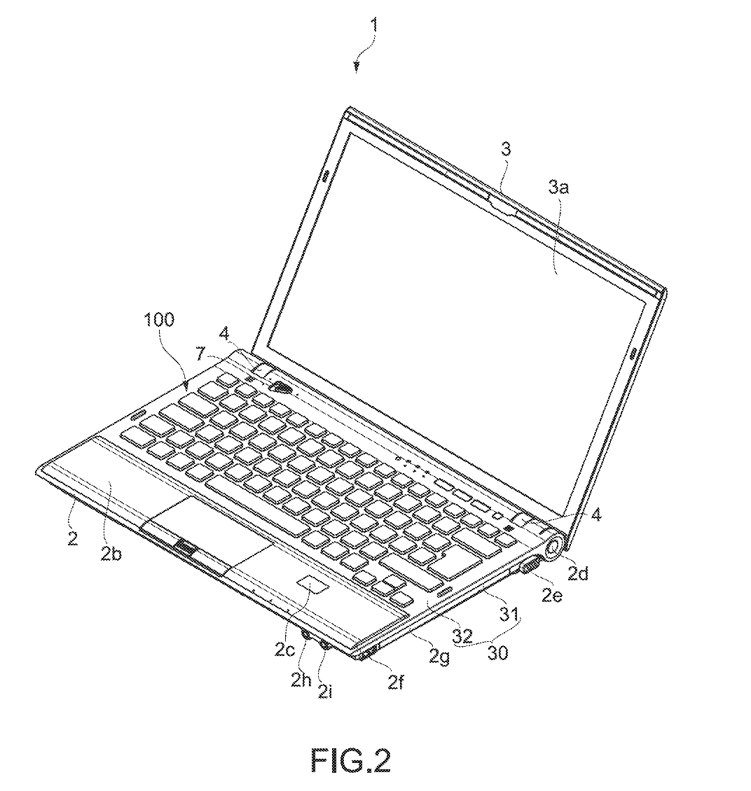

FIG. 2 is a perspective view showing an example of an electronic device of a first embodiment.

In this embodiment, a laptop personal computer (hereinafter simply referred to as PC) is used as an example of the electronic device, and description will be made.

A PC 1 includes a main body unit 2 and a display unit 3. Hinges 4, 4 couple the main body unit 2 and the display unit 3. The main body unit 2 and the display unit 3 are capable of rotating relatively. The display unit 3 includes a display screen 3a. The display screen 3a faces the main body unit 2 in a state where the display unit 3 is closed with respect to the main body unit 2. The main body unit 2 includes a backlight keyboard 100, a palm rest 2b, an antenna 2c for non-contact IC (Integrated Circuit) cards, and a slide-type switch 7. The backlight keyboard 100, the palm rest 2b, the antenna 2c, and the slide-type switch 7 face the display unit 3 in a state where the display unit 3 is closed with respect to the main body unit 2. A user puts his wrists on the palm rest 2b when he inputs operations. The main body unit 2 further includes, on the side surfaces of the main body unit 2, a power switch 2d, an external display output terminal 2e, a USB (Universal Serial Bus) connector 2f, a disk insertion slot 2g of a disk drive (not shown), a microphone input terminal 2h, and a headphone output terminal 2i. The main body unit 2 further includes, inside, a CPU (Central Processing Unit), a ROM (Read Only Memory), a RAM (Random Access Memory), a nonvolatile memory (HDD (Hard Disk Drive), flash memory, another solid memory), a mother board, and the like (not shown).

[Structure of Backlight Keyboard of this Embodiment]

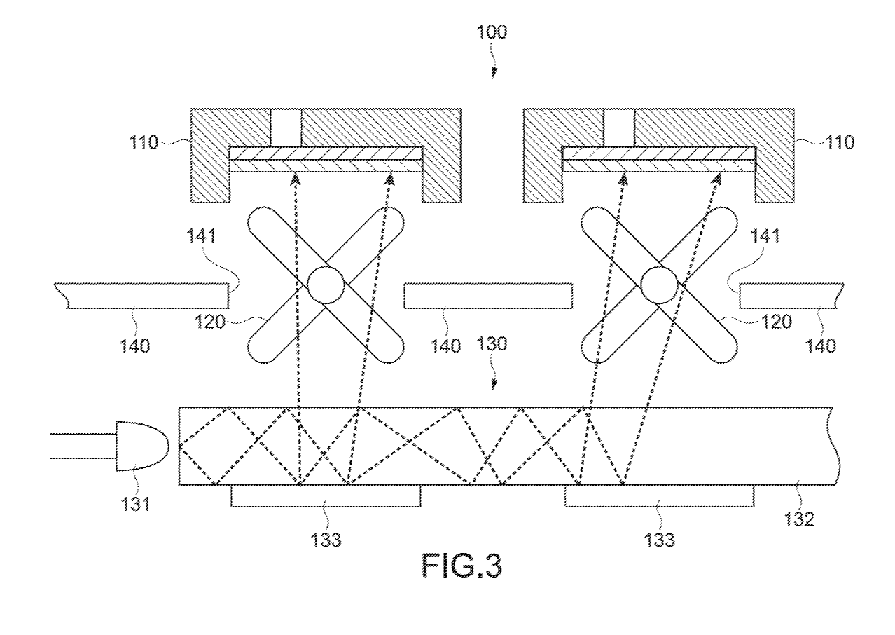

FIG. 3 is a schematic diagram showing the structure of the backlight keyboard of this embodiment.

The backlight keyboard 100 (illuminating device) includes a plurality of keycaps 110 at the top portion. A pantograph 120 and the like are provided inside each keycap 110. The pantograph 120 moves up-and-down when the keycap 110 is pressed. A plate 140 includes a plurality of openings 141. The openings 141 face the pantographs 120, respectively. The pantographs 120 are exposed from the openings 141, respectively. Membrane switches (not shown) are provided below the plurality of keycaps 110, respectively. The keycap 110 is pressed. Then, the contact of the membrane switch, which locates immediately below the keycap 110, is closed. The contact is electrically conducted. Information on the pressed key is transmitted to the CPU.

A light source unit 130 (light source) is arranged below the membrane switches. The light source unit 130 includes a light emission unit 131, a light guide plate 132, and diffuser panels 133.

The light emission unit 131 is arranged next to a side surface of the light guide plate 132. The light emission unit 131 emits ultra violet (UV) light (hereinafter referred to as UV light) to the inside of the light guide plate 132. The wavelength of UV light is invisible.

The light guide plate 132 faces all the keycaps 110. The light guide plate 132 is made of an acrylic plate, for example. The acrylic plate has high optical transparency. Minute asperity is formed on the upper and lower inner surfaces of the light guide plate 132. The light emission unit 131 emits UV light (dotted lines). The UV light is reflected by the asperity formed on the upper and lower inner surfaces again and again, and travels in the light guide plate 132. As a result, UV light runs through the entire light guide plate 132.

The diffuser panels 133 are provided on the lower surface of the light guide plate 132. For example, the diffuser panels 133 are provided at positions facing the keycaps 110, respectively. Print dots are formed on the top surface of the diffuser panel 133. The sizes of the print dots are designed such that they emit light uniformly. Thanks to a refraction function of a lens array, the diffuser panels 133 diffuse UV light to the back surfaces of the keycaps 110, respectively. As described above, the light source unit 130 emits UV light (light having first wavelength) to the keycaps 110.

### [Structure of Keycap]

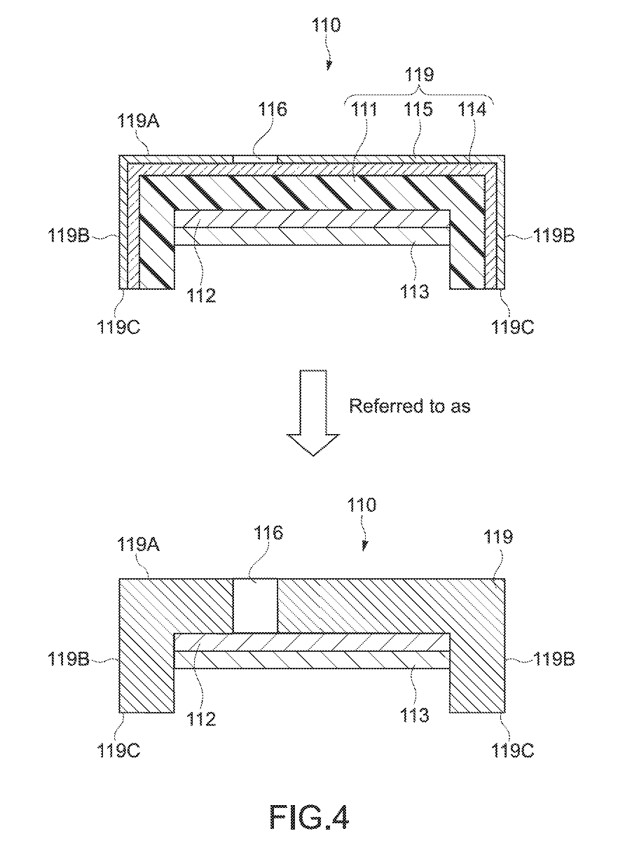

FIG. 4 is a sectional view showing the structure of a keycap.

The keycap 110 includes a bandpass filter 113, a UV light reactive layer 112, a base material 111, a light transmissive layer 114, and a light untransmissive layer 115. The light untransmissive layer 115 includes a light transmissive opening 116. The bandpass filter 113, the UV light reactive layer 112, the base material 111, the light transmissive layer 114, and the light untransmissive layer 115 are layered in this order from the lower layer (side facing light source unit 130) to the upper layer (side exposed from main body unit 2 of PC 1).

The base material 111 allows visible light to pass through.

The UV light reactive layer 112 (first light reactive portion) is layered on the back surface (surface facing light source unit 130) of the base material 111. UV light (dotted line) (light having first wavelength) from the light source unit 130 excites the UV light reactive layer 112. The UV light reactive layer 112 emits visible light (solid line) (visible light having second wavelength).

The bandpass filter 113 (filter portion) is provided as a lower layer of the UV light reactive layer 112. The bandpass filter 113 allows UV light from the light source unit 130 to pass through. The bandpass filter 113 allows the UV light to reach the UV light reactive layer 112. Further, the UV light, which has passed through the bandpass filter 113, excites the UV light reactive layer 112. The UV light reactive layer 112 emits visible light. The bandpass filter 113 shields the visible light.

The light transmissive layer 114 is coated on the top surface of the base material 111, and is thus formed. The UV light excites the UV light reactive layer 112. The UV light reactive layer 112 emits visible light. The visible light passes through the base material 111. The light transmissive layer 114 allows the visible light to pass through.

The light untransmissive layer 115 is coated on the light transmissive layer 114. Visible light passes through the light transmissive layer 114. The light untransmissive layer 115 does not allow the visible light to pass through. That is, the light untransmissive layer 115 prevents the visible light from leaking to the outside of the keycap 110. A cover unit 119 of the keycap 110 includes the base material 111, the light transmissive layer 114, and the light untransmissive layer 115.

The cover unit 119 includes an operation surface 119A and side surfaces 119B. A user operates the operation surface 119A. The side surfaces 119B protrude from the operation surface 119A in the direction of the light source unit 130. The operation surface 119A includes a light transmissive portion 116.

Specifically, a part of the light untransmissive layer 115 is removed by laser etching, for example. The light transmissive opening 116 (light transmissive portion) is thus formed. Specifically, the light transmissive opening 116 is an alphabet or symbol portion on the top surface of the keycap 110. The light transmissive layer 114 allows visible light to pass through. The light transmissive opening 116 allows the visible light to pass through. The light transmissive opening 116 guides a part of the visible light to the outside of the keycap 110. As a result, the alphabet or symbol portion being the light transmissive opening 116 emits light visibly.

Note that, in the following drawings, the base material 111, the light transmissive layer 114, and the light untransmissive layer 115 may sometimes not be separated from each other in order to simplify the drawings. The base material 111, the light transmissive layer 114, and the light untransmissive layer 115 may sometimes be correctively referred to as the cover unit 119. Here, only the light untransmissive layer 115 includes the light transmissive opening 116. However, the base material 111 and the light transmissive layer 114 also allow light to pass through. In view of this, in the drawings, the entire cover unit 119 includes the light transmissive opening 116. Here, the light transmissive opening 116 shows a continuous functional portion, which allows light to pass through.

### [Method of Manufacturing Keycap]

FIG. 5 is a schematic diagram showing a method of manufacturing the keycap.

The base material 111 is prepared (ST1). The base material 111 allows visible light to pass through. Paint is coated on the back surface of the base material, and is cured. The paint emits visible light when UV light excites the paint. As a result, the UV light reactive layer 112 is formed (ST2). The bandpass filter 113 is formed on the back surface of the UV light reactive layer 112 (ST3). The bandpass filter 113 allows UV light to pass through, and shields visible light. The bandpass filter 113 is formed by coating and curing paint, or by adhesively attaching a film. Paint is coated on the top surface and the side surfaces of the base material 111, and is cured. The paint allows visible light to pass through. As a result, the light transmissive layer 114 is formed (ST4). Paint is coated on the top surface of the light transmissive layer 114, and is cured. The paint does not allow visible light to pass through. As a result, the light untransmissive layer 115 is formed (ST5). The light untransmissive layer 115 is partially (in shape of alphabet or symbol) removed by laser etching. As a result, the light transmissive opening 116 is formed (ST6). The light transmissive opening 116 is formed on the light untransmissive layer 115. A top coat 117 is coated on the top surface of the light untransmissive layer 115, and is cured (ST7).

### [Effects of First Embodiment]

There is known an electronic device including the following keyboard (backlight keyboard). That is, a keycap main body of a keyboard is opaque. An alphabet or a symbol on the keycap is transparent. Backlight emits light to the keyboard, to thereby illuminate the alphabet or the symbol (for example, see Japanese Patent Application Laid-open No. 2008-71735 and Japanese Patent Application Laid-open No. 2010-170825.).

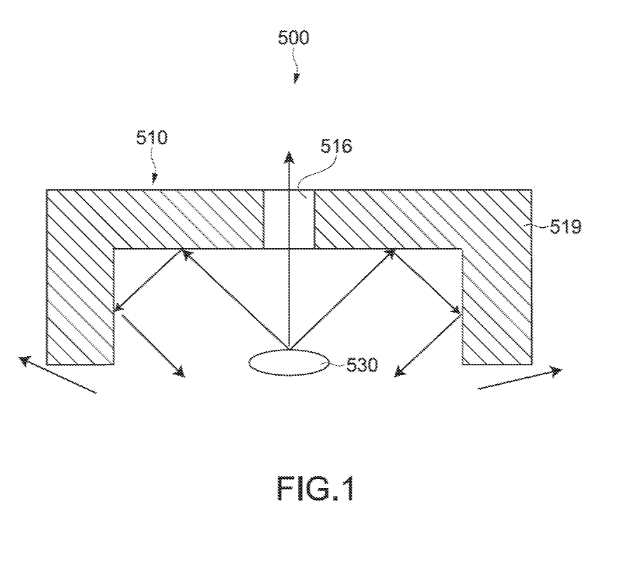

FIG. 1 is a schematic diagram showing a typical backlight keyboard.

A typical backlight keyboard 500 includes a keycap 510 and a light source unit 530. The light source unit 530 emits visible light (solid line). The keycap 510 includes a cover unit 519 and a light transmissive opening 516. Note that, in FIG. 1 and the diagrams described below, each light source unit is simplified. However, in fact, each light source unit has a structure similar to the structure of the light source unit 130 of FIG. 3, and arranged at the similar position.

The light source unit 530 of the backlight keyboard 500 emits visible light. A part of the visible light passes through the light transmissive opening 516, and is guided to the outside of the keycap 510. Meanwhile, another part of the visible light, which is emitted from the light source unit 530, may leak from the surroundings of the keycap 510, specifically, from a gap between the keycap 510 and a plate (not shown, corresponding to plate 140 of FIG. 3). As a result, light is emitted from the surroundings of the keycap 510. An alphabet or a symbol on the top surface of the keycap 510 is backlit. As a result, visibility of the alphabet or the symbol may be reduced. Further, the contrast of light of the alphabet or the symbol, which emits light, may be reduced. An aesthetic impression may thus be reduced.

To the contrary, the backlight keyboard 100 of this embodiment is capable of preventing light from leaking from the surroundings of the keycap 110, specifically, from the gap between the keycap 110 and the plate 140 (FIG. 3), which is effective. More specifically, the backlight keyboard 100 of this embodiment has the following effects.

(1) UV light excites the UV light reactive layer 112. The UV light reactive layer 112 emits visible light. A part of the visible light travels below the keycap 110. The bandpass filter 113 is a lower layer next to the UV light reactive layer 112. The bandpass filter 113 shields the visible light. As a result, the visible light may not leak from the surroundings of the keycap 110, specifically, from the gap between the keycap 110 and the plate 140.

(2) The light source unit 130 emits light. A part of the light does not reach the bandpass filter 113. The part of the light travels to edge portions 119C of the side surfaces 119B of the cover unit 119. Let's say that light emitted from the light source unit 130 is visible light. In this case, the visible light leaks from the surroundings of the keycap 110, specifically, from the gap between the edge portions 119C of the cover unit 119 and the plate 140. However, in this embodiment, the light source unit 130 emits light having a UV wavelength. The UV wavelength is an invisible wavelength. Because of this, visible light may not leak from the surroundings of the keycap 110, specifically, from the gap between the edge portions 119C of the cover unit 119 and the plate 140.

(3) As described above, visible light may not leak from the edge portions 119C of the cover unit 119, specifically, from the gap between the keycap 110 and the plate 140, to the surroundings of the keycap 110. As a result, an alphabet or a symbol on the top surface of the keycap 110 may not be backlit. The alphabet or the symbol emits light. Visibility of the alphabet or the symbol may thus be increased. As a result, contrast of light emitted from the alphabet or the symbol is increased. An aesthetic impression is thus increased.

(4) As described above, according to this embodiment, optical decoration property of a device may be increased by means of light modulation.

### Second Embodiment

Hereinafter, structures, functions, and the like similar to the above-mentioned structures, functions, and the like will not be described. Different points will mainly be described.

### [Structure of Keycap]

FIG. 7 is a schematic diagram showing the structure of a backlight keyboard of a second embodiment.

A backlight keyboard 200 includes a keycap 210 and a light source unit 230. The light source unit 230 includes a blue LED (Light Emitting Diode). The blue LED emits blue light as visible light. The keycap 210 includes a cover unit 219, a blue light reactive layer 212, a light transmissive opening 216, and a bandpass filter 213. The blue light reactive layer 212 is a lower layer next to the cover unit 219. The light transmissive opening 216 is provided on the cover unit 219. The bandpass filter 213 is provided as the lower layer of the blue light reactive layer 212.

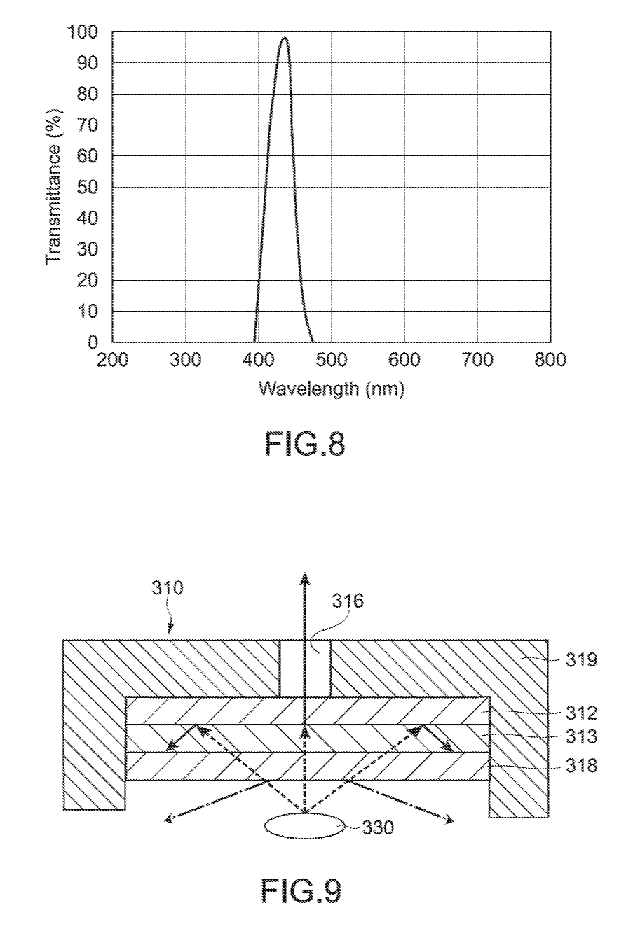

FIG. 8 is a diagram showing the transparent wavelength of the bandpass filter.

The bandpass filter 213 allows light having a blue wavelength (450 to 495 nm) to pass through, and shields light having the other wavelength.

The light source unit 230 emits blue light (dotted line). The blue light excites the blue light reactive layer 212. The blue light reactive layer 212 emits yellow light. The yellow light, which is emitted from the blue light reactive layer 212, mixes with blue light from the light source unit 230. The mixture is pseudo white light (solid line). The pseudo white light passes through the light transmissive opening 216, and is guided to the outside of the keycap 210.

Meanwhile, a part of the blue light from the light source unit 230 is reflected by the top surface of the blue light reactive layer 212. The light reflected by the top surface of the blue light reactive layer 212 is yellow light. This is because blue light excites the blue light reactive layer 212.

The light is reflected by the top surface of the blue light reactive layer 212, and turns to the yellow light (solid line). The bandpass filter 213 shields the yellow light. Because of this, the yellow light may not leak from the surroundings of the keycap 210. As a result, a part of blue light (dotted line) (light having first wavelength) travels from the keycap 210 as it is (blue light). Here, the blue light is emitted from the light source unit 230. The blue light is visible light. Yellow light does not interfere with the blue light. As a result, clear blue light may be emitted from the surroundings of the keycap 210. Further, the keycap 210 has a simple structure including one blue light reactive layer 212 and one bandpass filter 213. The color (pseudo white) of light from the light transmissive opening 216 (light transmissive portion) is different from the color (blue) of light from the surroundings of the keycap 210. In addition, the color (pseudo white) of the light and the color (blue) of the light are clear. An aesthetic impression is increased.

### [Effects of Second Embodiment]

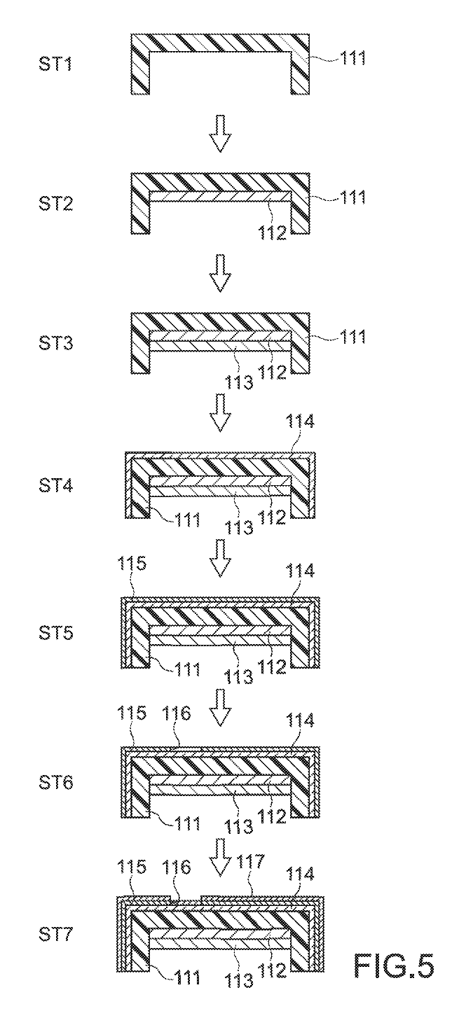

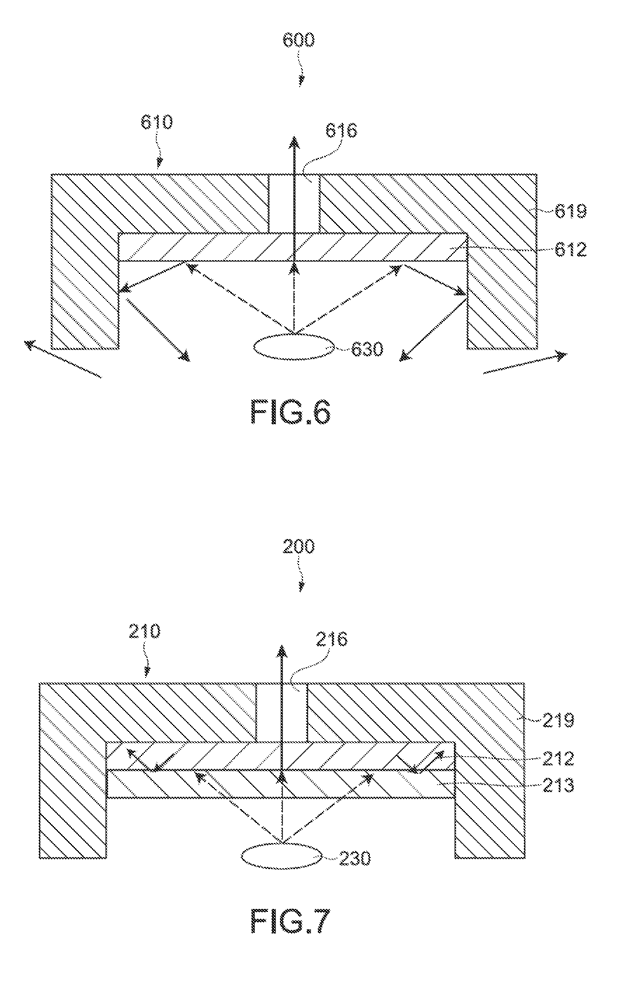

FIG. 6 is a schematic diagram showing a typical backlight keyboard.

The structure of a backlight keyboard 600 is similar to the structure of FIG. 7 except that the backlight keyboard 600 does not include the bandpass filter 213.

A part of blue light from a light source unit 630 is reflected by the top surface of a blue light reactive layer 612. Blue light excites the blue light reactive layer 612. As a result, the light, which is reflected by the top surface of the blue light reactive layer 612, is yellow light. The reflected yellow light leaks from the surroundings of a keycap 610. Meanwhile, a part of the blue light from the light source unit 630 does not reach the blue light reactive layer 612. The part of the blue light leaks from the surroundings of the keycap 610 as it is (blue light). That is, yellow light and blue light leak from the surroundings of the keycap 610. As a result, the yellow light and the blue light, which leak from the surroundings of the keycap 610, interfere with each other. The yellow light and the blue light turn to pseudo white light (solid line). Let's say that, for example, the amount of yellow light is larger than the amount of blue light. In this case, as a result, blue light, which is emitted from the light source unit 630, does not leak from the surroundings of the keycap 610 as it is. Instead, thanks to the pseudo white light, pale murky whitish blue light leaks from the surroundings of the keycap 610.

As described above, according to the related art, the color of light emitted from a light transmissive opening 616 may be different from the color of light emitted from the surroundings of the keycap 610. However, as described above, yellow light reflected by the blue light reactive layer 612 interferes with blue light from the light source unit 630. As a result, blue light emitted from the surroundings of the keycap 610 is murky.

To the contrary, according to the backlight keyboard 200 of this embodiment, light emitted from the surroundings of a keycap is not interfered with by other light, which is effective.

That is, according to the structure of this embodiment, optical decoration property of a device may be increased by means of light modulation.

### Third Embodiment

The structure of a third embodiment is different from the structure of the second embodiment. According to the third embodiment, it is desirable to make the color (alphabet color) of light from a light transmissive opening different from the color of light from the surroundings of a keycap. In addition, it is desirable to make each color clear.

### [Structure of Keycap]

FIG. 9 is a schematic diagram showing the structure of a keycap of the third embodiment.

A keycap 310 includes a second UV light reactive layer 318, a bandpass filter 313, a first UV light reactive layer 312, and a cover unit 319. The cover unit 319 includes a light transmissive opening 316. The second UV light reactive layer 318, the bandpass filter 313, the first UV light reactive layer 312, and the cover unit 319 are layered in this order from the lower layer to the upper layer.

The first UV light reactive layer 312 is the lower layer next to a light transmissive layer 314. UV light (dotted line) (light having first wavelength) excites the first UV light reactive layer 312. The first UV light reactive layer 312 emits visible light (solid line) having a second wavelength. A part of the visible light, which is emitted from the first UV light reactive layer 312 and has the second wavelength, passes through the light transmissive layer 314 and the light transmissive opening 316 (light transmissive portion). The part of the visible light is guided to the outside of the keycap 310. As a result, an alphabet or symbol portion as the light transmissive opening 316 emits visible light having the second wavelength.

The second UV light reactive layer 318 is provided as a lower layer of the first UV light reactive layer 312. The second UV light reactive layer 318 and the first UV light reactive layer 312 sandwiches the bandpass filter 313. UV light (dotted line) (light having first wavelength) from a light source unit 330 excites the second UV light reactive layer 318. The second UV light reactive layer 318 emits visible light (dashed-dotted line) having a third wavelength. The third wavelength (color) of the visible light is different from the second wavelength of visible light. A part of the visible light, which is emitted from the second UV light reactive layer 318 and has the third wavelength, travels from the surroundings of the keycap 310.

The bandpass filter 313 is arranged between the first UV light reactive layer 312 and the second UV light reactive layer 318. The bandpass filter 313 allows UV light from the light source unit 330 to pass through. As a result, the UV light from the light source unit 330 reaches the first UV light reactive layer 312. Further, the UV light, which has passed through the bandpass filter 313, excites the first UV light reactive layer 312. The first UV light reactive layer 312 emits visible light having the second wavelength. The bandpass filter 313 shields the visible light having the second wavelength. Further, the UV light from the light source unit 330 excites the second UV light reactive layer 318. The second UV light reactive layer 318 emits visible light having the third wavelength. The bandpass filter 313 shields the visible light having the third wavelength.

### [Effects of Third Embodiment]

(1) UV light excites the second UV light reactive layer 318. The second UV light reactive layer 318 emits visible light having the third wavelength. The bandpass filter 313 shields a part of the visible light. As a result, the visible light having the third wavelength may not leak from the light transmissive opening 316. Because of this, only the visible light having the second wavelength passes through the light transmissive opening 316. Because of this, the visible light having the second wavelength is not interfered with by the visible light having the third wavelength. As a result, clear visible light having the second wavelength may be emitted from the light transmissive opening 316.

(2) UV light excites the first UV light reactive layer 312. The first UV light reactive layer 312 emits visible light having the second wavelength. The bandpass filter 313 shields a part of the visible light. The bandpass filter 313 is the lower layer next to the first UV light reactive layer 312. Because of this, the visible light having the second wavelength may not leak from the surroundings of the keycap 310. As a result, only the visible light having the third wavelength travels from the surroundings of the keycap 310. Because of this, the visible light having the second wavelength may not interfere with the visible light having the third wavelength. As a result, clear visible light having the third wavelength may be emitted from the surroundings of the keycap 310.

(3) Paint as the first UV light reactive layer 312 is arbitrarily selected. Light having an arbitrary color may thus be emitted. Paint as the second UV light reactive layer 318 is arbitrarily selected. Light having an arbitrary color may thus be emitted. One light emission unit may generate light having a plurality of colors. Because of this, the number of the light emission units may be smaller than the structure in which single-purpose color light emission units are provided for a plurality of different colors, respectively, for example.

As described above, according to the structure of this embodiment, optical decoration property of a device may be increased by means of light modulation.

### Fourth Embodiment

The structure of a fourth embodiment is different from the structure of the second embodiment and from the structure of the third embodiment. According to the fourth embodiment, it is desirable to make the color (alphabet color) of light from a light transmissive opening different from the color of light from the surroundings of a keycap. In addition, it is desirable to make each color clear.

### [Structure of Keycap]

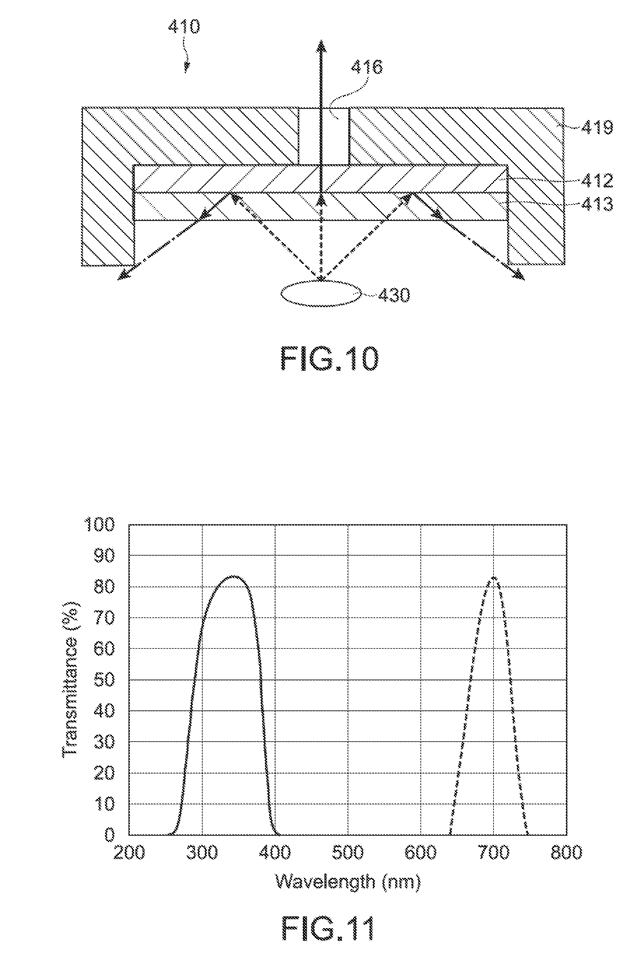

FIG. 10 is a schematic diagram showing the structure of a keycap of a fourth embodiment.

A keycap 410 includes a bandpass filter 413, a UV light reactive layer 412, and a cover unit 419. The cover unit 419 includes a light transmissive opening 416. The bandpass filter 413, the UV light reactive layer 412, and the cover unit 419 are layered in this order from the lower layer to the upper layer.

FIG. 11 is a diagram showing the transparent wavelength of the bandpass filter.

The bandpass filter 413 allows UV light and a part of visible light to pass through wavelength-selectively. The bandpass filter 413 shields light having the other wavelengths. For example, the bandpass filter 413 allows UV light (specifically, for example, UV B (280 to 315 nm) and UV A (315 to 400 nm)) and red light (620 to 750 nm) to pass through. Because of this, the bandpass filter 413 allows UV light from a light source unit 430 to pass through. The UV light reaches the UV light reactive layer 412. In addition, UV light, which has passed through the bandpass filter 413, excites the UV light reactive layer 412. The UV light reactive layer 412 emits visible light (white light). The bandpass filter 413 allows red light out of the visible light (white light) to pass through.

UV light (dotted line) (light having first wavelength) excites the UV light reactive layer 412. The UV light reactive layer 412 emits visible light (white light, solid line). A part of the visible light passes through the light transmissive opening 416 (light transmissive portion). The part of the visible light is guided to the outside of the keycap 410. Meanwhile, a part of the visible light (white light), which is emitted from the UV light reactive layer 412, enters the bandpass filter 413. The bandpass filter 413 allows red light (dashed-dotted line) out of the visible light (white light) to pass through. The bandpass filter 413 shields visible light having the other wavelengths. As a result, only red light passes through the bandpass filter 413, and leaks from the surroundings of the keycap 410.

As described above, according to this embodiment, the color (alphabet color) of light from the light transmissive opening 416 is different from the color of light, which leaks from the surroundings of the keycap 410. Light does not interfere with other light, and the color of the light is not murky, and vice versa. Further, the keycap 410 includes one reactive layer 412 and one bandpass filter 413. With this simple structure, the color (alphabet color) of light from the light transmissive opening 416 is different from the color of light, which leaks from the surroundings of the keycap 410. In addition, the alphabet color is clear, and the color of light, which leaks from the surroundings of the keycap 410, is clear. The bandpass filter 413 having an arbitrary transparent wavelength property is selected. As a result, light having an arbitrary color may be emitted from the surroundings of the keycap 410.

That is, according to the structure of this embodiment, optical decoration property of a device may be increased by means of light modulation.

### Modification 1

A light emission unit emits weak visible light having violet wavelength. The light emission unit may include a bandpass filter. The bandpass filter shields the weak visible light. As a result, the weak visible light may not leak from the surroundings of a keycap.

### Modification 2

First UV light reactive layers may be provided on base materials (first base materials) of some of a plurality of keycaps, respectively. Second UV light reactive layers may be provided on base materials (second base materials) of the other keycaps, respectively. Color of light emitted from the first UV light reactive layers is different from color of light emitted from the second UV light reactive layers. As a result, the alphabet color of some keycaps may be different from the alphabet color of the other keycaps.

Alternatively, a first UV light reactive layer and a second UV light reactive layer may be provided for a plurality of light transmissive portions (alphabet and symbol) on one keycap, respectively. Color of light emitted from the first UV light reactive layer is different from color of light emitted from the second UV light reactive layer. As a result, the color of an alphabet on a keycap may be different from the color of a symbol on the same keycap. As described above, the first UV light reactive layer and second UV light reactive layer are used. Color of light emitted from the first UV light reactive layer is different from color of light emitted from the second UV light reactive layer. As a result, one light emission unit may set the color of an alphabet and the color of a symbol arbitrarily. Further, paint, which is coated as a UV light reactive layer, is arbitrarily selected. As a result, the color of an alphabet may be toned depending on design.

According to this modification, optical decoration property of a device may be increased by means of light modulation.

### Modification 3

According to the first embodiment, paint is coated on the base material. As a result, the UV light reactive layer is formed. UV light excites the paint, and the paint emits visible light. Instead, a material of the base material may include paint, and the paint may be in a base material. That is, a base material may be manufactured from a material including paint.

### Modification 4 to Modification 10

Each of a modification 4 to a modification 10 is a modification of the keycap 110 of the first embodiment. According to the first embodiment, the UV light reactive layer 112 emits visible light. The bandpass filter 113 shields the visible light. The bandpass filter 113 is arranged as the lower layer next to the UV light reactive layer 112. As a result, the visible light is prevented from leaking from the surroundings of the keycap 110. In view of this, the present technology is not limited to the specific layer order of the first embodiment. The bandpass filter 113 may be at least lower than the UV light reactive layer 112. Then, the bandpass filter 113 is capable of preventing visible light, which is emitted from the UV light reactive layer 112, from leaking from the surroundings of the keycap 110. Further, the light untransmissive layer 115 including the light transmissive opening 116 may be at least upper than the UV light reactive layer 112. Then, visible light, which is emitted from the UV light reactive layer 112, may pass through the light transmissive opening 116, and may reach the outside of the keycap 110.

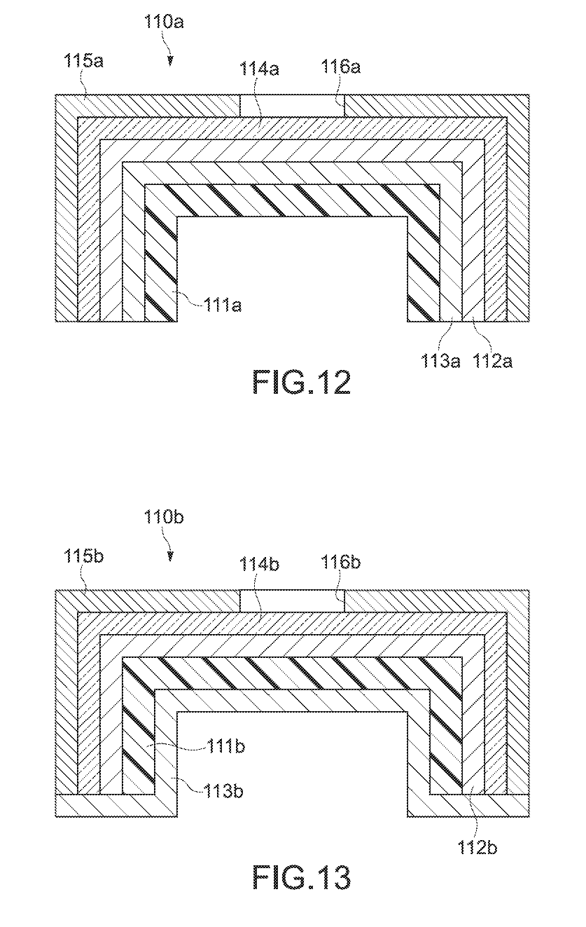

FIG. 12 is a schematic diagram showing a keycap of the modification 4.

A keycap 110a includes a base material 111a, a bandpass filter 113a, a UV light reactive layer 112a, a light transmissive layer 114a, and a light untransmissive layer 115a. The light untransmissive layer 115a includes a light transmissive opening 116a. The base material 111a, the bandpass filter 113a, the UV light reactive layer 112a, the light transmissive layer 114a, and the light untransmissive layer 115a are layered in this order from the lower layer to the upper layer. The UV light reactive layer 112a emits visible light. A part of the visible light passes through the light transmissive layer 114a and the light transmissive opening 116a. The part of the visible light is guided to the outside of the keycap 110a. The bandpass filter 113a shields the other part of the visible light, which is emitted from the UV light reactive layer 112a. As a result, visible light may not leak from the surroundings of the keycap 110a.

FIG. 13 is a schematic diagram showing a keycap of a modification 5.

A keycap 110b includes a bandpass filter 113b, a base material 111b, a UV light reactive layer 112b, a light transmissive layer 114b, and a light untransmissive layer 115b. The light untransmissive layer 115b includes a light transmissive opening 116b. The bandpass filter 113b, the base material 111b, the UV light reactive layer 112b, the light transmissive layer 114b, and the light untransmissive layer 115b are layered in this order from the lower layer to the upper layer. The UV light reactive layer 112b emits visible light. A part of the visible light passes through the light transmissive layer 114b and the light transmissive opening 116b. The part of the visible light is guided to the outside of the keycap 110b. The other part of the visible light, which is emitted from the UV light reactive layer 112b, passes through the base material 111b. The bandpass filter 113b shields the other part of the visible light. As a result, visible light may not leak from the surroundings of the keycap 110b.

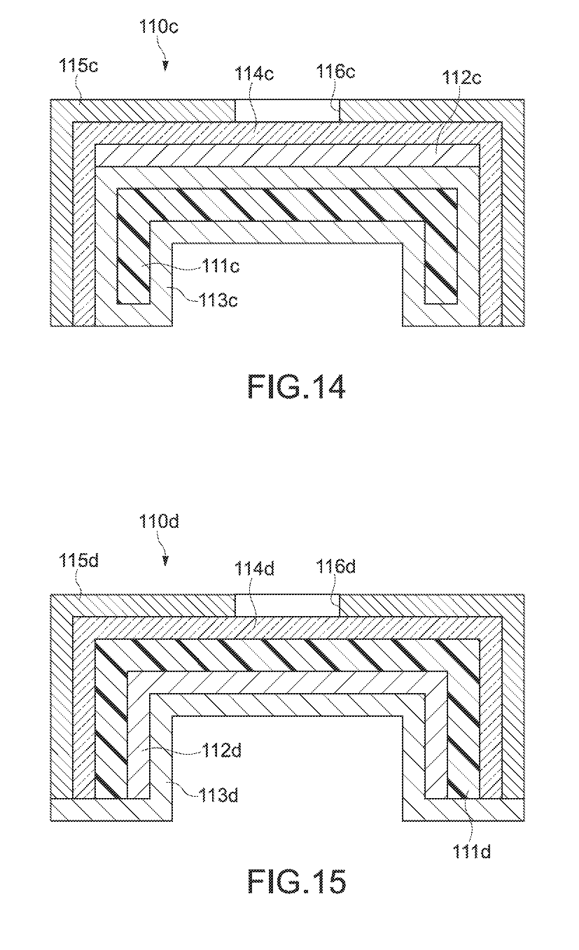

FIG. 14 is a schematic diagram showing a keycap of a modification 6.

A keycap 110c includes a bandpass filter 113c, a base material 111c, the bandpass filter 113c, a UV light reactive layer 112c, a light transmissive layer 114c, and a light untransmissive layer 115c. The light untransmissive layer 115c includes a light transmissive opening 116c. The bandpass filter 113c, the base material 111c, the bandpass filter 113c, the UV light reactive layer 112c, the light transmissive layer 114c, and the light untransmissive layer 115c are layered in this order from the lower layer to the upper layer. The UV light reactive layer 112c emits visible light. A part of the visible light passes through the light transmissive layer 114c and the light transmissive opening 116c. The part of the visible light is guided to the outside of the keycap 110c. The bandpass filter 113c shields the other part of the visible light, which is emitted from the UV light reactive layer 112c. As a result, visible light may not leak from the surroundings of the keycap 110c.

FIG. 15 is a schematic diagram showing a keycap of a modification 7.

A keycap 110d includes a bandpass filter 113d, a UV light reactive layer 112d, a base material 111d, a light transmissive layer 114d, and a light untransmissive layer 115d. The light untransmissive layer 115d includes a light transmissive opening 116d. The bandpass filter 113d, the UV light reactive layer 112d, the base material 111d, the light transmissive layer 114d, and the light untransmissive layer 115d are layered in this order from the lower layer to the upper layer. The UV light reactive layer 112d emits visible light. A part of the visible light passes through the base material 111d, the light transmissive layer 114d, and the light transmissive opening 116d. The part of the visible light is guided to the outside of the keycap 110d. The bandpass filter 113d shields the other part of the visible light, which is emitted from the UV light reactive layer 112d. As a result, visible light may not leak from the surroundings of the keycap 110d.

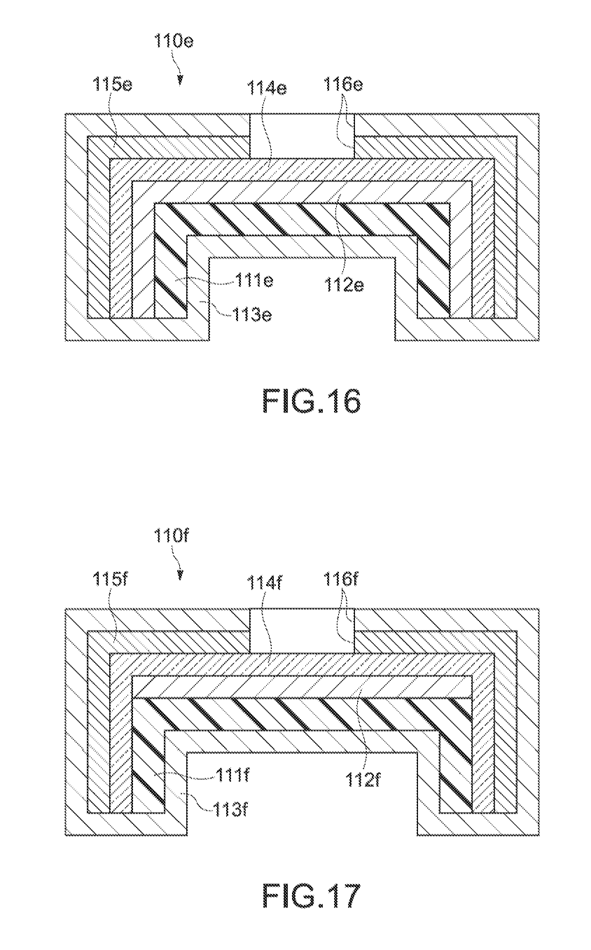

FIG. 16 is a schematic diagram showing a keycap of a modification 8.

A keycap 110e includes a bandpass filter 113e, a base material 111e, a UV light reactive layer 112e, a light transmissive layer 114e, a light untransmissive layer 115e, and the bandpass filter 113e. The light untransmissive layer 115e includes a light transmissive opening 116e. The bandpass filter 113e includes a light transmissive opening 116e. The bandpass filter 113e, the base material 111e, the UV light reactive layer 112e, the light transmissive layer 114e, the light untransmissive layer 115e, and the bandpass filter 113e are layered in this order from the lower layer to the upper layer. The light transmissive opening 116e of the light untransmissive layer 115e and the light transmissive opening 116e of the bandpass filter 113e are continuous. The UV light reactive layer 112 emits visible light. A part of the visible light passes through the light transmissive layer 114e and the light transmissive openings 116e. The part of the visible light is guided to the outside of the keycap 110e. The bandpass filter 113e shields the other part of the visible light, which is emitted from the UV light reactive layer 112e. As a result, visible light may not leak from the surroundings of the keycap 110e.

FIG. 17 is a schematic diagram showing a keycap of a modification 9.

A keycap 110f includes a bandpass filter 113f, a base material 111f, a UV light reactive layer 112f, a light transmissive layer 114f, a light untransmissive layer 115f, and the bandpass filter 113f. The light untransmissive layer 115f includes a light transmissive opening 116f. The bandpass filter 113f includes a light transmissive opening 116f. The bandpass filter 113f, the base material 111f, the UV light reactive layer 112f, the light transmissive layer 114f, the light untransmissive layer 115f, and the bandpass filter 113f are layered in this order from the lower layer to the upper layer. The light transmissive opening 116f of the light untransmissive layer 115f and the light transmissive opening 116f of the bandpass filter 113f are continuous. The UV light reactive layer 112f emits visible light. A part of the visible light passes through the light transmissive layer 114f and the light transmissive openings 116f. The part of the visible light is guided to the outside of the keycap 110f. The other part of the visible light, which is emitted from the UV light reactive layer 112f, passes through the base material 111f. The bandpass filter 113f shields the other part of the visible light. As a result, visible light may not leak from the surroundings of the keycap 110f.

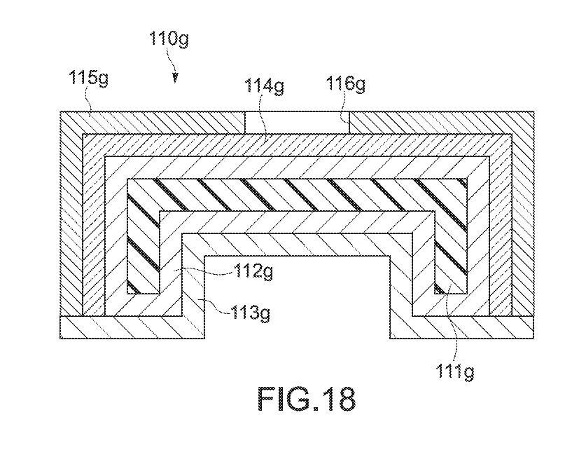

FIG. 18 is a schematic diagram showing a keycap of the modification 10.

A keycap 110g includes a bandpass filter 113g, a UV light reactive layer 112g, a base material 111g, the UV light reactive layer 112g, a light transmissive layer 114g, and a light untransmissive layer 115g. The light untransmissive layer 115g includes a light transmissive opening 116g. The bandpass filter 113g, the UV light reactive layer 112g, the base material 111g, the UV light reactive layer 112g, the light transmissive layer 114g, and the light untransmissive layer 115g are layered in this order from the lower layer to the upper layer. The UV light reactive layers 112g emit visible light. A part of the visible light passes through the light transmissive layer 114g and the light transmissive opening 116g. The part of the visible light is guided to the outside of the keycap 110g. The bandpass filter 113g shields the other part of the visible light, which is emitted from the UV light reactive layers 112g. As a result, visible light may not leak from the surroundings of the keycap 110g.

As described above, according to the modification 4 to the modification 10, optical decoration property of a device may be increased by means of light modulation.

### Modification 11

In the above-mentioned embodiment, the light emission unit 131 of the light source unit 130 emits light. The light guide plate 132 propagates the light. The diffuser panels 133 diffuse the light to the back surfaces of the keycaps 110. However, the present technology is not limited to this. A light emission unit may be arranged below the keycaps. A light guide plate and a diffuser panel may not be used. Light from the light emission unit may directly reach the back surfaces of the keycaps.

### Other Modifications

In this embodiment, a PC is used as an electronic device including an illuminating device. Alternatively, there may be used a keyboard externally connected to a PC, a terminal device such as a mobile phone or a mobile audio visual device, a mobile game machine, a PDA (Personal Digital Assistance), an imaging device such as a digital camera or a digital video camera, an on-screen keyboard, an electric dictionary, a display device, an audio visual device, a projector, a game machine, a robot device, other electric equipment, or the like.

In this embodiment, a backlight keyboard is used as an illuminating device. However, the present technology is not limited to this. An illuminating device may be a device including a member, which has the structure similar to the structure of the keycap of this embodiment, and a light source unit. The structure of the keycap of this embodiment is the following structure. That is, a bandpass filter is provided inside. A light reactive layer is at least provided as an upper layer of the bandpass filter. A light untransmissive layer is provided as an upper layer of the light reactive layer. The light untransmissive layer includes a light transmissive opening. Examples of an illuminating device include an electronic device such as a PC (portion other than keyboard. For example, cover unit of laptop PC. Cover unit is back side of display screen), a toy, and the like. Alternatively, a device mainly for optical decoration or decorative illumination may be used as an illuminating device.

Note that the present technology may employ the following structure.

(1) An electronic device, comprising:

a light source configured to emit light having a first wavelength;

a first light reactive portion configured to emit visible light having a second wavelength when the first light reactive portion is excited by the light from the light source;

a filter portion arranged between the light source and the first light reactive portion, the filter portion being configured
to allow the light having the first wavelength to pass through, and
to shield the visible light having the second wavelength emitted from the first light reactive portion; and

a cover unit including a light transmissive portion, the light transmissive portion allowing a part of the visible light having the second wavelength emitted from the first light reactive portion to pass through.

(2) The electronic device according to (1), wherein

the first light reactive portion is between the light transmissive portion and the filter portion.

(3) The electronic device according to (1) or (2), wherein

the cover unit includes an operation surface operated by a user, and

the operation surface includes the light transmissive portion.

(4) The electronic device according to any one of (1) to (3), wherein

the light source is configured to emit invisible light as the light having the first wavelength.

(5) The electronic device according to any one of (1) to (4), further comprising:

a second light reactive portion arranged between the light source and the filter portion, the second light reactive portion being configured to emit visible light having a third wavelength when the second light reactive portion is excited by the light having the first wavelength from the light source, the visible light having the third wavelength being different from the visible light having the second wavelength, wherein

the filter portion is configured to further shield the visible light having the third wavelength emitted from the second light reactive portion.

(6) The electronic device according to any one of (1) to (5), wherein

the filter portion is configured to allow a part of the visible light having the second wavelength emitted from the first light reactive portion to pass through.

The present disclosure contains subject matter related to that disclosed in Japanese Priority Patent Application JP 2012-182797 filed in the Japan Patent Office on Aug. 21, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device, comprising:
a light source configured to emit light having a first wavelength;
a first light reactive portion configured to emit visible light having a second wavelength when the first light reactive portion is excited by the light from the light source;
a filter portion arranged between the light source and the first light reactive portion, the filter portion being configured
to allow the light having the first wavelength to pass through, and
to shield the visible light having the second wavelength emitted from the first light reactive portion; and
a cover unit including a light transmissive portion, the light transmissive portion allowing a part of the visible light having the second wavelength emitted from the first light reactive portion to pass through.

2. The electronic device according to claim 1, wherein
the first light reactive portion is between the light transmissive portion and the filter portion.

3. The electronic device according to claim 2, wherein
the cover unit includes an operation surface operated by a user, and
the operation surface includes the light transmissive portion.

4. The electronic device according to claim 3, wherein
the light source is configured to emit invisible light as the light having the first wavelength.

5. The electronic device according to claim 4, further comprising:
a second light reactive portion arranged between the light source and the filter portion, the second light reactive portion being configured to emit visible light having a third wavelength when the second light reactive portion is excited by the light having the first wavelength from the light source, the visible light having the third wavelength being different from the visible light having the second wavelength, wherein
the filter portion is configured to further shield the visible light having the third wavelength emitted from the second light reactive portion.

6. The electronic device according to claim 4, wherein
the filter portion is configured to allow a part of the visible light having the second wavelength emitted from the first light reactive portion to pass through.

7. An illuminating device, comprising:
a light source configured to emit light having a first wavelength;
a first light reactive portion configured to emit visible light having a second wavelength when the first light reactive portion is excited by the light from the light source;
a filter portion arranged between the light source and the first light reactive portion, the filter portion being configured
to allow the light having the first wavelength to pass through, and
to shield the visible light having the second wavelength emitted from the first light reactive portion; and
a cover unit including a light transmissive portion, the light transmissive portion allowing a part of the visible light having the second wavelength emitted from the first light reactive portion to pass through.

8. An illuminating method, comprising:
emitting, from a light source, light having a first wavelength;
emitting, from a first light reactive portion, visible light having a second wavelength when the first light reactive portion is excited by the light from the light source;
allowing, by a filter portion arranged between the light source and the first light reactive portion, the light having the first wavelength to pass through, and shielding the visible light having the second wavelength emitted from the first light reactive portion; and
allowing, by a light transmissive portion of a cover unit, a part of the visible light having the second wavelength emitted from the first light reactive portion to pass through.

9. A method of manufacturing an illuminating device, comprising:
layering a first light reactive portion on a surface of a cover unit, the first light reactive portion being configured to emit visible light having a second wavelength when the first light reactive portion is excited by light having a first wavelength;
layering a filter portion on the first light reactive portion, the filter portion being configured to allow the light having the first wavelength to pass through, and to shield the visible light having the second wavelength emitted from the first light reactive portion; and
forming a light transmissive portion on the cover unit, the light transmissive portion allowing a part of the visible light having the second wavelength emitted from the first light reactive portion to pass through.
